(19) United States
(12) Patent Application Publication
(10) Pub. No.: US 2004/0039778 A1
(43) Pub. Date: Feb. 26, 2004

(54) Internet communication

(76) Inventors: Richard Read, Reddish (GB); Simon Bargate, Marple (GB); Mark Jones, Leftwich (GB)

Correspondence Address: PIPER RUDNICK, P. O. BOX 64807, CHICAGO, IL, 60664-0807, US

(21) Appl. No.: 10/297,098

(22) PCT Filed: May 25, 2001
(86) PCT No.: PCT/GB01/02318

(30) Foreign Application Priority Data
May 27, 2000 (GB) 0012859.5

(51) Int. Cl. G06F 15/16; G09G 5/00

(52) U.S. Cl. 709/203; 345/752

(57) ABSTRACT

A communications system comprising a Web server hosting a Web site accessible via the Internet by first and second users, wherein the Web server is configured to allow the first user to send an electronic communication to the second user, the Web server being configured to receive identification details from the first user and an electronic communication from the first user, the Web server being configured to retain the electronic communication and, upon receiving identification details from the second user, to allow the second user to view open the electronic communication, wherein the Web server retains status information indicating whether the electronic communication has been opened by the second user, the status information being accessible to at least the first user.

The present invention relates to Internet communication.

There are many known forms of Internet communication, for example email messages and voice messages. Internet communications are sent using the Transmission Control Protocol (TCP) and Internet Protocol (IP) and/or using the Wireless Application Protocol (WAP) or other mobile Internet connection technologies.

Conventionally, an email message bearing the address of an intended recipient is sent from a user's computer to a mail server, and from the mail server onto the Internet. The email message travels through the Internet to the mail server of the intended recipient.

When a user wishes to check whether he has received any email messages, he logs onto his mail server which will inform him if he has new email messages. If the user does have new email messages, these are downloaded to the user's computer and opened using mail reader software.

A user may be a private subscriber to an Internet Service Provider (ISP). Where this is the case, when he wishes to check his messages he connects his computer via a telephone link to the mail server of the ISP. The mail server will inform the user if he has any new email messages; the new email messages are downloaded onto the user's computer so that he may read them.

A user may be an employee of a company that has an intranet. Where this is the case, his computer may be connected during working hours via that intranet to a mail server. Whenever the mail server receives an email message addressed to the user, it sends the email message to the user's computer. If the email message is from another employee of the company, then the email will travel from the sender to the recipient via the intranet, and will not travel via the Internet. An email message from outside of the company will be received via the Internet.

Email messages may be sent and received from any suitable electronic device, for example it is possible to send email messages from mobile telephones using the Wireless Application Protocol.

It is possible to send voice messages via the Internet, for example from mobile telephones using the Wireless Application Protocol.

At least one known email communication system, Lotus Notes (proprietary trademark), includes a facility whereby an email message arriving at its destination automatically triggers an email to be sent from that destination back to the sender of the email. This system suffers from the disadvantage that it does not indicate whether or not the email has been opened by the intended recipient.

A disadvantage of known Internet communication systems is that it is difficult to determine with certainty whether an electronic communication has reached its destination and has been opened by the intended recipient.

It is an object of the present invention to provide a communication system that overcomes or mitigates the above disadvantage.

According to a first aspect of the invention there is provided a communications system comprising a Web server hosting a Web site accessible via the Internet by first and second users, wherein the Web server is configured to allow the first user to send an electronic communication to the second user, the Web server being configured to receive identification details from the first user and an electronic communication from the first user, the Web server being configured to retain the electronic communication and, upon receiving identification details from the second user, to allow the second user to view open the electronic communication, wherein the Web server retains status information indicating whether the electronic communication has been opened by the second user, the status information being accessible to at least the first user.

The term ‘opened’ is intended to mean that the electronic communication is viewed via a suitable device by the second user, or if the electronic communication is in an audio format, that the electronic communication has been played by a suitable device to the user.

The term ‘electronic communication’ is intended to mean any communication capable of being sent via the Internet, for example using the Transmission Control Protocol (TCP), Internet Protocol (IP) and/or the Wireless Application Protocol (WAP) or other mobile Internet connection technologies.

The electronic communication may be sent by the first user from any suitable device. A suitable device is any device capable of communicating via the Internet, for example using TCP/IP and/or WAP or other mobile Internet connection technologies. Examples of suitable devices include computers, mobile telephones, television set-top boxes.

Similarly, the electronic communication may be opened by the second user using any suitable device.

Suitably, the status information is accessible to the second user.

Suitably, the status information indicates when the electronic communication was opened by the second user.

Suitably, the Web server retains the electronic communication, and is configured to allow the electronic communication to be accessed by the first and second users.

This is an important difference between the invention and conventional Internet communication systems. In a conventional system, for example conventional email, an email message is composed at a first computer and sent to a second computer. A copy of the email message is retained on the hard drive of the first computer, and, once received, is retained on the hard drive of the second computer. In contrast to this, an electronic communication composed according to the invention is provided to the Web site via the first user's computer, and is retained on the hard drive of the Web site server. The electronic communication is not retained on the hard drive of the first user's computer. When the second user opens the electronic communication, the communication is not transferred to the hard drive of the second user, but is simply displayed at the second user's computer. When reading the communication the second user is effectively viewing a page of the Web site.

Suitably, the electronic communication that has been retained by the Web server cannot be altered by any user.

Suitably, when the first or second user wishes to modify the electronic communication that has been retained at the Web server, the web server is configured to retain the modified electronic communication in addition to the original unmodified communication.

By configuring the system to prevent users from changing any previously sent communications, a hierarchy of documents is retained at the Web site, which indicates how and when a given communication evolved. The communication could be for example a legal document that is amended in turn by several lawyers, each amendment resulting in the creation of a new document.

Suitably, the Web server is configured to allow additional predetermined users to access the status information or to the electronic communication.

Suitably, the identification details required by the Web server from the first and/or second users include that user's password, or some other unique security reference.

Suitably, in addition to indicating that an electronic communication has been opened by the second user, the status information indicates the length of time that the electronic communication remained open.

Suitably, the Web server is configured to allow a user to determine who is authorised to send messages to him.

Suitably, the Web server is configured to allow a user to specify other users that are authorised to open messages which have previously been opened by him.

Suitably, the Web server, upon receiving the message for the second user, is configured to notify the second user that a new message has been received.

Suitably, the Web server is configured to notify the second user by sending an appropriate message to the second user.

Suitably, the Web server is configured to compare the source of the new message with a set of users for which the second user has provided notification authorisation, and to notify the second user only if the source of the message is included in the set of users for which notification authorisation has been provided.

Suitably, the Web server is administrated by a third party, and is accessed by the first and second users via the Internet.

Suitably, the Web server is administrated by the first user and the Web server may be accessed by the first user via an intranet, wherein in order to open the electronic communication sent by the first user the second user must access the Web server via the Internet.

Suitably, the electronic communication comprises text which is written into a Web browser by the first user and then transferred to the Web server.

Suitably, the electronic communication is a voice message.

The invention also provides a method of facilitating communication between first and second users via a Web server hosting a Web site accessible via the Internet, the method comprising receiving at the Web server identification details from the first user together with an electronic communication, retaining the electronic communication at the Web server, receiving identification details from the second user, then allowing the second user to open the electronic communication, the method further comprising retaining status information at the Web server indicating whether the electronic communication has been opened by the second user, the status information being accessible to at least the first user.

The method may incorporate any of the features of the apparatus referred to above.

A specific embodiment of the invention will now be described by way of example only, with reference to the accompanying figures, in which:

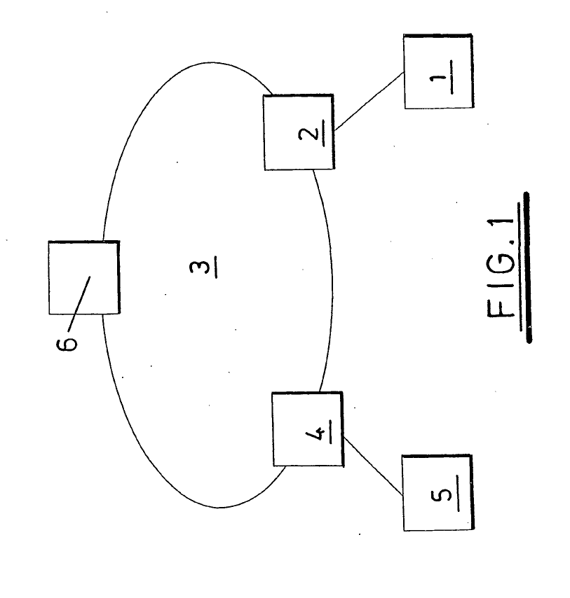

FIG. 1 is a schematic illustration of the invention; and

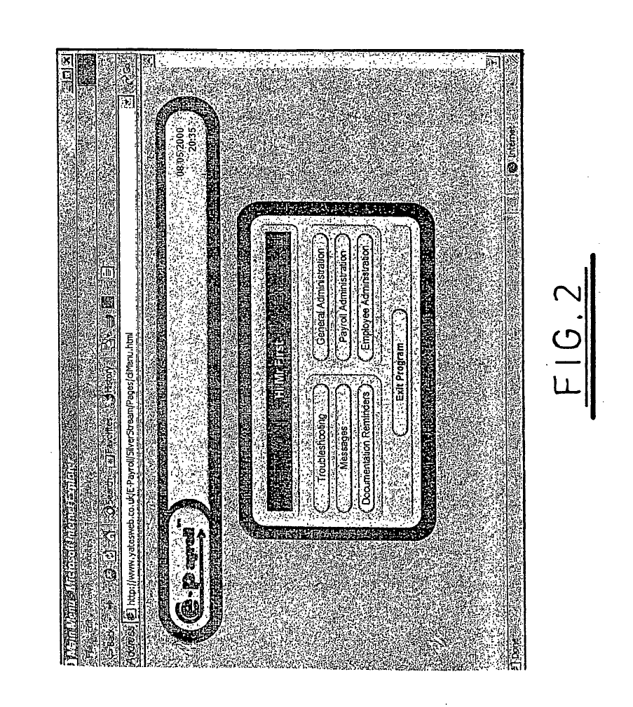

FIGS. 2 to 14 are screen prints from a Web site which embodies the invention.

The Internet may be considered to be a cloud comprising many interconnections which carry data between computers. The nature of the design of the Internet is such that there is no central entity or hub through which all data passes. Data is broken into packets using the Transmission Control Protocol (TCP) and is delivered to its destination via routers in accordance with an Internet Protocol (IP) address.

The invention allows a user to know with certainty if and when a message has been received and opened by an intended recipient. A Web site is set up on a Web site server which is connected to the Internet. The Web site is administrated by a commercial company. Users may subscribe to the Web site under a subscription scheme run by the company, for example by payment of a monthly fee.

Referring to FIG. 1, a first user and a second user are subscribers to the Web site run on a Web site server 6. When a first user wishes to send an electronic communication to a second user, and wishes to be able to determine whether the second user has received and opened the electronic communication, the first user does not send an email via the Internet in the conventional manner, but instead logs onto the Web site run at the Web site server 6.

The first user runs a known Web browser, for example Microsoft Internet Explorer (proprietary trademark), on his computer 1. The first user enters the Uniform Resource Locator (URL) of the Web site server 6 into the Web browser, which transfers the request via a server 2 onto the Internet. The Web site server 6 sends the ‘login’ page of the Web site to the Web browser of the first computer 1 via the server 2. The first user logs on to the Web site server 6 using a user identification and corresponding password.

Once logged on to the Web site, the first user selects a ‘Write Message’ option at the Web site. The Web site server sends a ‘Write Message’ page to the Web browser of the first computer 1. The write message page includes a text box in which the first user duly writes the message. The first user uses the Write Message page to select the second user from a list of people that subscribe to the Web site, thereby addressing the message to the second user. Once the user has addressed the message he indicates that he is happy for the message to be sent, and the message is transferred from the Web browser of the first computer 1 to the Web site server 6 via the Internet. The message is retained at the Web site server 6. The Web site indicates to the first user that his electronic communication has been retained at the Web site server 6. The electronic communication is not sent to the server 4 used by the second user.

When the second user wishes to check his mail, he accesses the Web site via his computer 5 and a server 4. The second user logs on to the Web site at the Web site server 6 using a Web browser. Upon entering his user identification and password, he will be notified that there is a message for him from the first user. The second user then selects an ‘open’ option at the Web site, the message may then be viewed by the second user using the Web browser (via the Internet 3 and the server 4).

The Web site server 6 keeps a record of what messages have been sent by subscribers to other subscribers, and keeps a record of which messages have been opened by their intended recipients. In the described example, if the first user wishes to determine whether the second user has received and opened his message, he logs into the Web site as before. The Web site will indicate that the message has been received and opened by the second user.

The record of messages is available for inspection by both the first and second users. This allows both users to see when any given message was sent, and when it was opened. It also allows the contents of each message to be viewed, without allowing alteration of the messages.

The use of user identification and passwords allows access by subscribers to the electronic communication records to be restricted. A user will authorise certain other users to send messages to him. Any other person wishing to send a message to the user must first obtain authorisation from the user. This is done by sending an authorisation request to the user via the web site. The user upon receiving the authorisation request responds appropriately by authorising (or refraining from authorising) future messages from that person. In this way unsolicited messages are avoided.

The invention provides a Web site that acts as an “honest broker” which is trusted by subscribers to keep an accurate record indicating when electronic communication were sent and when they were received.

The first and second users may be for example a lawyer and his client, with access to the electronic communication records being restricted to those two subscribers. Alternatively, the first and second users may be part of a four way consortium between industrial companies, with each company being allowed access to the record of electronic communication between the four companies.

Some companies, and in particular large companies may wish to run the Web site on a server which belongs to that company and is located behind an appropriate firewall. The company may stipulate that all electronic messages sent from (to) the company to (from) other parties be sent using the Web site. Where this is done, a company employee writes a message which is retained at the Web site server. The intended recipient of the message must log on to the Web site via the Internet in order to read the message (the intended recipient of the message may be notified that he has an unread message, as described further below).

Where two companies wish to communicate with each other without relinquishing control of the record of sent messages, both companies may operate their own Web site. The Web sites may be set up so that messages sent by each company are retained at the Web site of that company. Thus, in order to view a message sent by a given company, a user must log on to the Web site run by that company. This allows the company to retain control of the messages sent by the company.

An email message may be a document drafted by the first user for review by the second user. If the second user wishes to make any changes to the document, then the system creates a new document which includes those changes. The original document is unchanged. The first user may then review the new document and make changes, which will result in the creation of a further new document. In this way, a hierarchy of document is retained at the Web site, which indicates how and when the document evolved. The document could for example be a legal document that is amended in turn by several lawyers, each amendment resulting in the creation of a new document.

An email message from the first user may comprise a short text together with an attached document, for example a Microsoft Word document. The second user may download the Microsoft Word document to his computer and make changes to it. The original Microsoft Word document is retained at the Web site. When the second user sends the altered Microsoft Word document (attached to an email) to the first user, this new document is retained at the Web site. This provides a hierarchy of Microsoft Word documents at the Web site.

An insurance company may require as part of an insurance policy that a customer read electronic communications sent to his home account. The policy could for example be liability insurance for a business. The insurer could require that all employees of the business read a document showing relevant Health and Safety regulations. When a new employee is employed by the business, the employee would be given a user identity and password and would then log on to the Web site and open the Health and Safety regulations document. The insurance company then has a permanent record indicating that the new employee read the Health and Safety regulations.

In a further example, a software company may sell software that is used, not by a customer downloading it and running it on his computer, but by the customer using the software at the Web site via a web browser. The software company may oblige a customer to log on to the Web site and read a set of terms and conditions for use of the software. The software company would then have a permanent record indicating that the customer had read the terms and conditions.

Access to the record of electronic communications may be tailored to a given subscriber's requirements. For example, there may be some instances in which a first user does not wish a second user to see the electronic communications record. An insurance company may wish to monitor whether a customer has read an electronic communication, but may not want the customer to have access to the record indicating what electronic communications were sent to him and when they were sent.

The Web site may be arranged to notify a user when an unread message addressed to that user is being held at the Web site server 6. For example, a conventional email message may be sent to an email account used by the user. Alternatively, an SMS text message may be sent to the user's telephone. The notification message will typically tell the user that he has an unread message, and may indicate the origin of the message. The user then logs on to the Web site in order to read the message. If the user has a Wireless Application Protocol (WAP) telephone (or other mobile telephone Internet connection technologies) then he may access the web site using the telephone; this will be particularly convenient if the notification message was received by the telephone (the notification message could be email or SMS text).

The user may chose whether or not to receive notification messages. This is done via a menu provided at the Web site. The user may chose to receive notification messages in respect of messages from a selection of people or all people that are authorised to send him messages.

The invention may be used for electronic voice communication via the Internet using the Wireless Application Protocol (WAP) or other mobile Internet connection technologies. For example, two users may subscribe to a service according to the invention. A first user may access the Web site from his mobile telephone by typing the Uniform Resource Locator (URL) of the Web site into his telephone. The first user is required to type a password into his telephone in order to gain access to the Web site. Once at the Web site he may record a voice message for a second user. The voice message is addressed to the second user. The second user accesses the Web site in order to check his voice messages. The Web site retains a record indicating when voice messages were recorded and when they were opened. The first and second users may also send written messages to each other via the Web site using their mobile telephones.

In addition to indicating when an electronic communication was opened, the record retained at the Web site may also indicate the length of time that the electronic communication remained open. In the case of a voice message, if the voice message was only open for 1 second, and the message was 10 seconds long, then it will be clear that the recipient of the voice message did not listen to the entire message. Similarly, if a written message was two pages long but was only opened for 2 seconds, then it may be inferred that the recipient of the email did not read it.

The Web site server 6 is accessed via the Internet, and is not an intranet server. This is an important distinction. Although intranets use TCP/IP networks and technologies, an intranet and its resources are used privately by a company and are not available to people outside that company. Intranets are separated from the Internet by firewalls that prevent unauthorised access. People who work in the company can access the intranet and use its resources, but intruders are kept out by the firewalls. All activity within an intranet may be monitored by servers which run the intranet. In this way it may be possible to determine whether a message sent via the intranet reached its intended recipient. In contrast to this, when the Internet is used to send a message it has not previously been possible to know with certainty that the message has reached its intended recipient. This is due in large part to the fact that the route taken by the message is unknown. The invention provides a way of determining whether a message sent via the Internet has been opened by an intended recipient. The invention may be used by any user via Internet, provided that the user is a subscriber to the system. This is advantageous because it is very much less expensive than providing an intranet between two users.

FIGS. 2 to 14 are a series of screen prints from a demonstration of a Web site according to the invention, comprising a payroll administration system.

A payroll administrator, Mr First, is in charge of providing payroll information for a factory, for example hours worked by employees at the factory. An accountant, Julie, calculates the wages and tax payable by each employee on the basis of information provided by Mr First. Both Mr First and Julie are subscribers to an electronic payroll system comprising a Web site according to the invention which is accessed by Mr First and Julie via the Internet.

When Mr First has information he wishes to send to Julie, or wishes to check whether information has been received from Julie, he logs onto the e-payroll (proprietary trademark) Web site. To do this, Mr First activates a web browser, in this case Microsoft Internet Explorer. He enters the Uniform Resource Locator (URL) www.yatesweb.co.uk (the address of the e-payroll Web site) into the web browser. The web browser passes this URL via a server to the Internet, and the Web site, once located sends a log on screen to Mr First. In order to log on to the Web site Mr First must enter a user identification and a password. Other known security devices may be utilised to prevent unauthorised access to the Web site.

Upon accessing the Web site Mr First is shown a menu of services, FIG. 2. Those buttons on the menu which are red (they will also be flashing on and off) indicate matters that require Mr First's attention. The first matter is an unread message to Mr First, and the second is a reminder that some documentation that is required by Julie is outstanding.

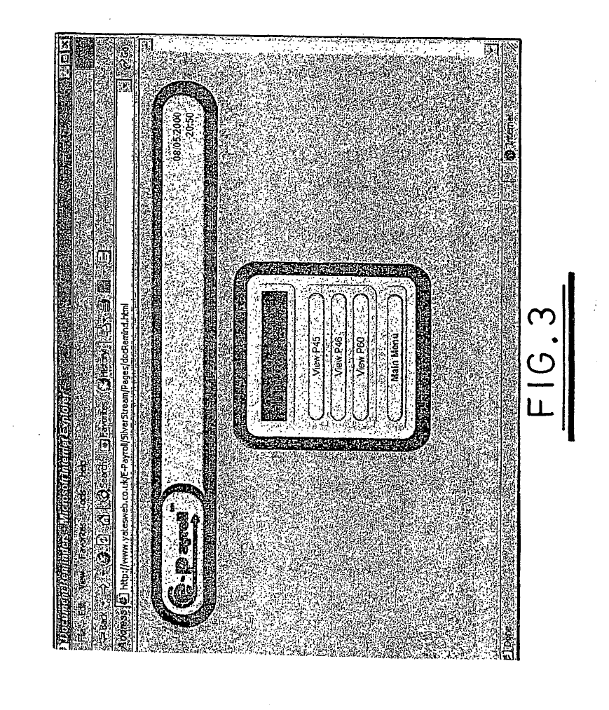

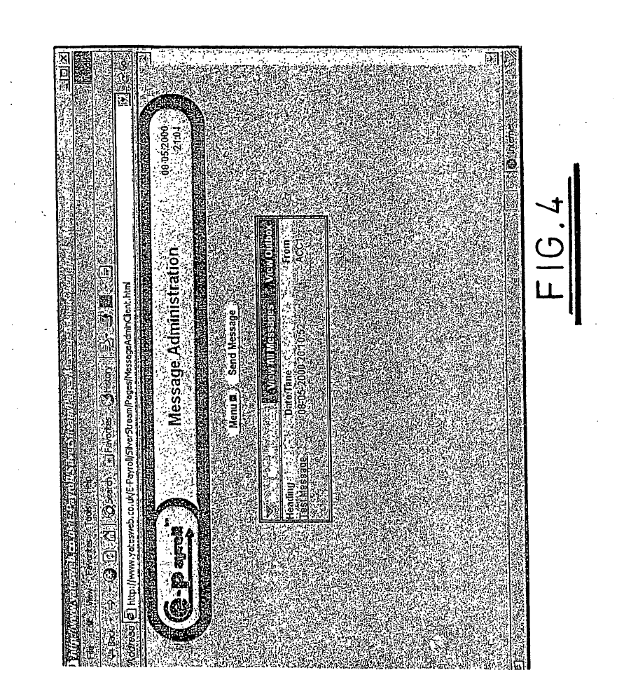

Mr First selects the “Documentation Reminders” button, whereupon a new screen of the Web site is displayed, FIG. 3. FIG. 3 shows a menu of documents pertinent to the payroll service. The “View P45” button is highlighted, indicating that there is an outstanding obligation to provide a P45 form for a given person to Julie. If Mr First were to select the “View P45” button he would be shown a further screen listing the name of those employees for which P45 forms are required by Julie. Mr First is not able to alter the status of the “View P45” button. The only way to alter the status of the button is to provide the required forms. Mr First selects the “Main Menu” button and then selects the “Messages” button, taking him to a new screen of the Web site, FIG. 4. FIG. 4 indicates that there is a new message, which is listed in the “View New Messages” box. The “View New Messages” box also indicates the date and time on which the new message was sent and the sender of the message.

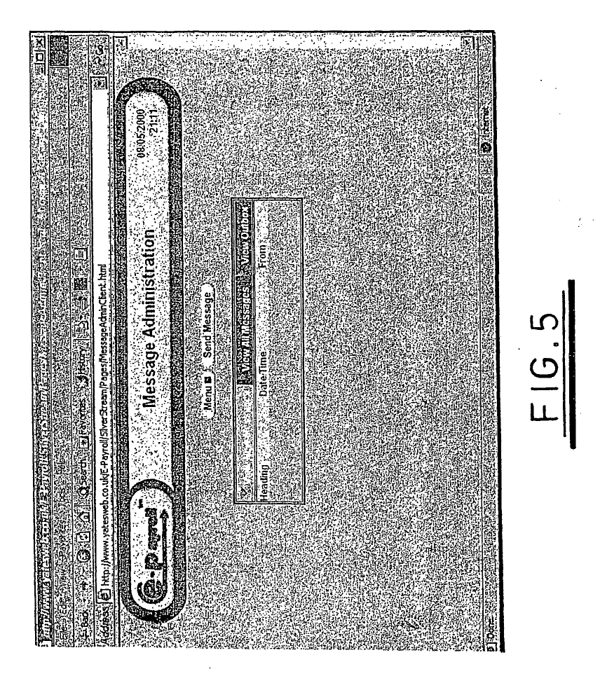

Mr First opens the message by selecting the heading of the message, in this case “Test Message”. The fact that the message has been opened is noted at the server which runs the Web site, and alters the status of the message on the Web site. The message is removed from the “View New Messages” box to the “View All Messages” list. This is illustrated in FIG. 5, where the “View New Messages” list is now empty.

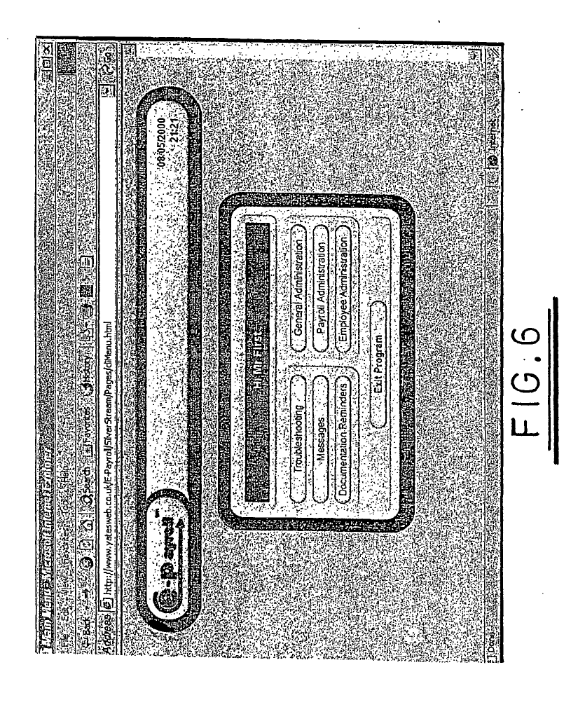

If Mr First were to return to the main menu, FIG. 6, the “Messages” button would no longer illuminated in red because there are no unread messages for Mr First.

Mr First sends a message titled “new test message” to Julie by selecting the “Send Messages” and writing the message which is headed with Julie's address (ACC1). When Mr First has composed his message, it is sent via the Internet to the server which runs the Web site. The message is retained at the server.

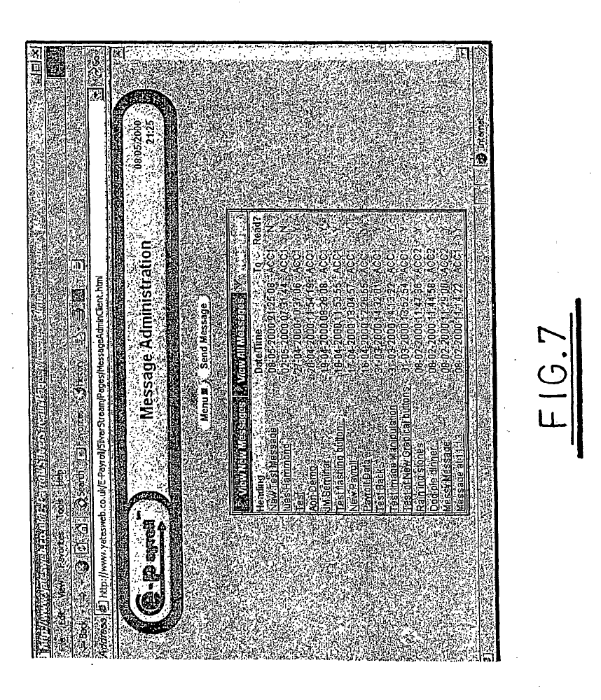

Mr First then wishes to check the status of a previous message that was sent to Julie, and selects the “View Outbox” box shown in FIG. 5. The Outbox screen of the Web site is shown in FIG. 7. The Outbox indicates that the letter titled “tues Hammond”, which was sent on May 2, 2000, has not yet been opened by Julie. As is expected, the new test message has also not been read by Julie. These messages are retained at the server which runs the Web site.

The Outbox keeps a log of all messages sent by Mr First, and indicates whether the messages have been opened. A message is considered to be opened when the intended recipient of the message logs on to the Web site and selects the heading of that message (thereby displaying that message at his computer).

All of the messages to Julie (ACC1) sent prior to May 2000 have been opened by Julie. Mr First has also sent some messages to a second subscriber, who has an address “ACC2”, on Feb. 8, 2000. These messages have been opened.

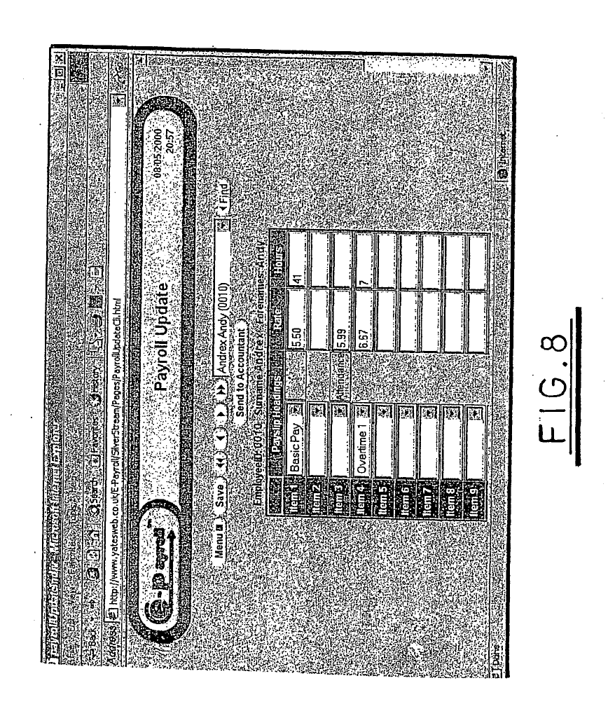

Mr First returns to the main menu and selects the “Payroll Administration” button. He is then presented with the payroll update screen, FIG. 8. Mr First enters pay information for an employee named Andy Andrex, including the number of hours worked for basic pay and the number of hours worked on a first overtime rate. The information is sent to Julie by pressing the “Send to Accountant” button.

Mr First then returns to the main menu and exits the Web site by pressing the “exit program” button.

The accountant, Julie, logs into the Web site from her office. To log on to the Web site she runs Microsoft Internet Explorer on her computer, and enters the Uniform Resource Locator (URL) www.yatesweb.co.uk. The web browser passes this URL via a server to the Internet, and the Web site once located sends a log on screen to Julie. Julie enters a user identification and a password to log on to the Web site.

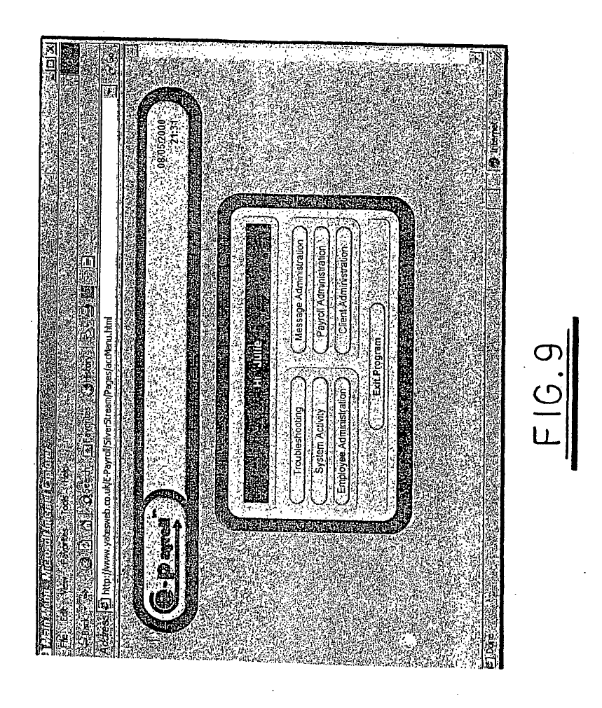

The main menu presented to Julie once she has logged on to the Web site is slightly different from the main menu presented to Mr First, and is shown as FIG. 9.

Julie's attention is drawn to the fact that there are unread messages for her, and there is unread payroll administration information. Julie opens the messages in the same manner as Mr First (not shown). Once opened, messages are transferred from a “View New Messages” box to a “View All Messages” box, and the “Message Administration” button is no longer illuminated in red. Julie may send messages to Mr First.

Julie selects the “Payroll Administration” button in the main menu, and is presented with payroll data (not illustrated). Julie accepts the payroll data and sends it to a payroll processing package. A message is automatically sent to Mr First indicating that the payroll data has been processed.

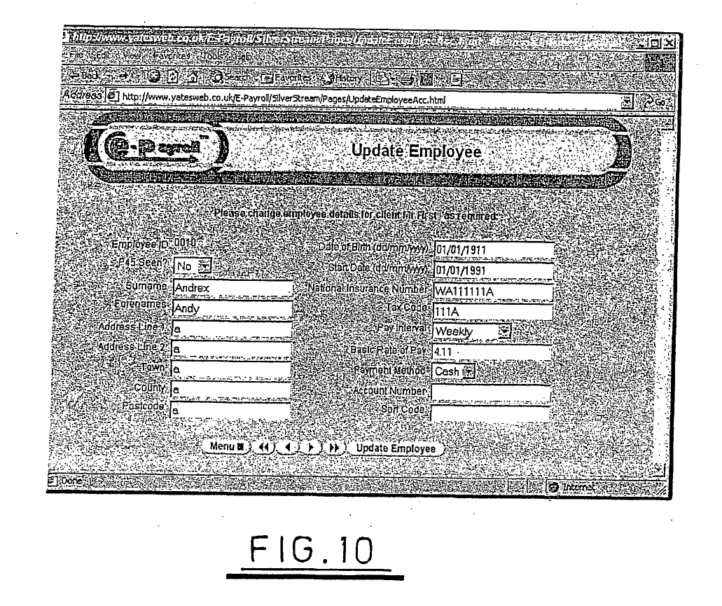

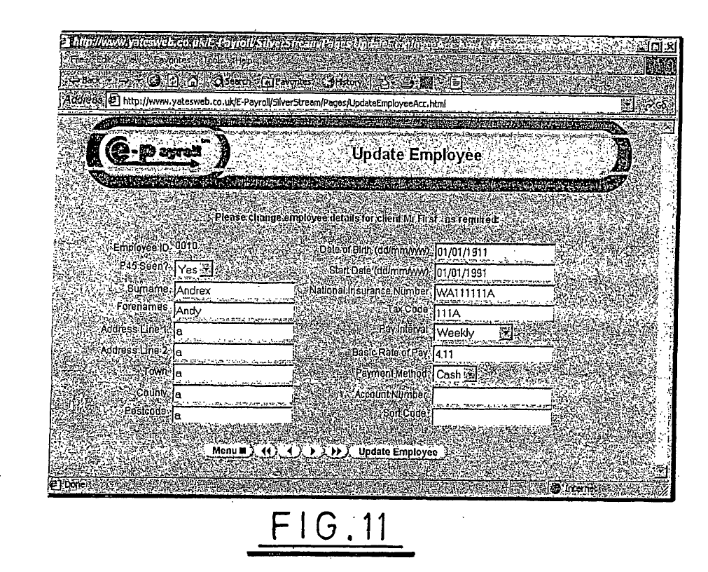

Julie then selects the “Employee Administration” button, and selects a data screen representing the employee details of Andy Andrex, FIG. 10. Julie has seen the P45 form required for Andy Andrex, and therefore updates the screen by changing the status of the “P4 Seen?” field from no to yes, FIG. 11. Julie then exits the Web site by selecting the “Exit Program” button in the main menu.

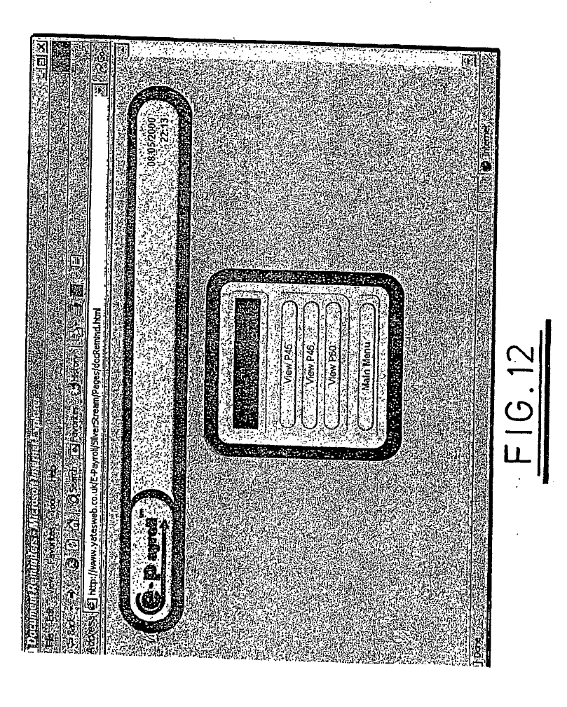

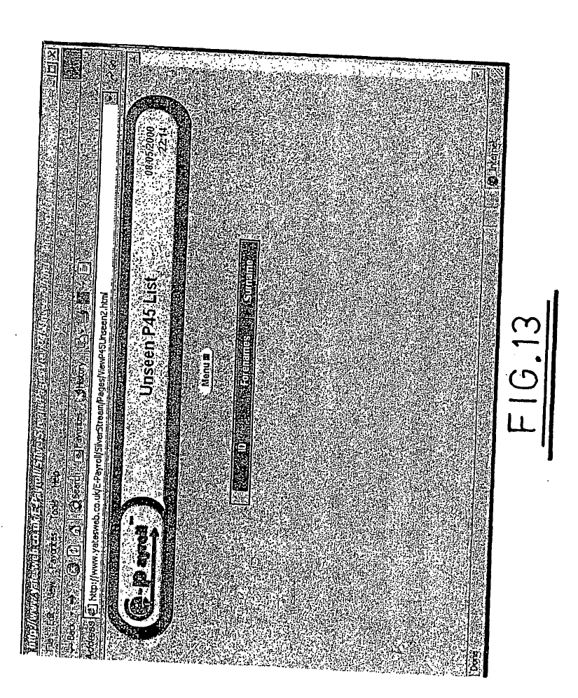

Since Julie has now acknowledged receipt of the required P45, when Mr First logs back on to the Web site, the documentation reminder button will no longer be illuminated, and similarly the view P45 reminder button will no longer be illuminated, as shown in FIG. 12. An “Unseen” P45 List” screen of the Web site indicates that no P45's are required, as shown in FIG. 13.

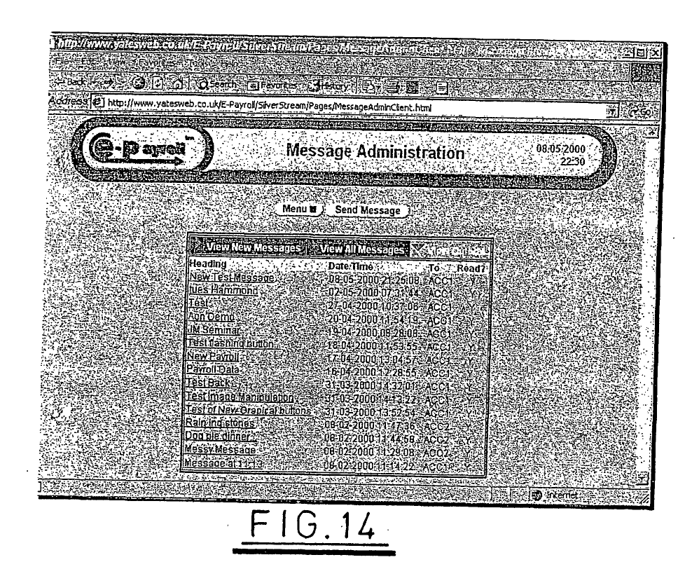

Mr First selects the “message Administration” screen of the Web site, FIG. 14, and checks the Outbox, which indicates that his message of 2 May and his message of 8 May to Julie have now been received.

Although the embodiment of the invention illustrated in FIGS. 2 to 14 relates to payroll information, it will be understood that the invention may be applied to any situation where electronic messages are sent via the Internet between two or more parties who wish to determine when those messages have been opened.

1. A communications system comprising a Web server hosting a Web site accessible via the Internet by first and second users, wherein the Web server is configured to allow the first user to send an electronic communication to the second user, the Web server being configured to receive identification details from the first user and an electronic communication from the first user, the Web server being configured to retain the electronic communication and, upon receiving identification details from the second user, to allow the second user to view open the electronic communication, wherein the Web server retains status information indicating whether the electronic communication has been opened by the second user, the status information being accessible to at least the first user.

2. A communications system according to claim 1, wherein the status information is accessible to the second user.

3. A communications system according to claim 1 or claim 2, wherein the status information indicates when the electronic communication was opened by the second user.

4. A communications system according to any preceding claim, wherein the Web server retains the electronic communication, and is configured to allow the electronic communication to be accessed by the first and second users.

5. A communications system according to claim 4, wherein the electronic communication that has been retained by the Web server cannot be altered by any user.

6. An communications system according to claim 5, wherein when the first or second user wishes to modify the electronic communication that has been retained at the Web server, the web server is configured to retain the modified electronic communication in addition to the original unmodified communication.

7. A communications system according to any preceding claim, wherein the Web server is configured to allow additional predetermined users to access the status information or to the electronic communication.

8. A communications system according to any preceding claim, wherein the identification details required by the Web server from the first and/or second users include that user's password, or some other unique security reference.

9. A communications system according to any preceding claim, wherein in addition to indicating that an electronic communication has been opened by the second user, the status information indicates the length of time that the electronic communication remained open.

10. A communications system according to any preceding claim, wherein the Web server is configured to allow a user to determine who is authorised to send messages to him.

11. A communications system according to any preceding claim, wherein the Web server is configured to allow a user to specify other users that are authorised to open messages which have previously been opened by him.

12. A communications system according to any preceding claim, wherein the Web server, upon receiving the message for the second user, is configured to notify the second user that a new message has been received.

13. A communications system according to claim 12, wherein the Web server is configured to notify the second user by sending an appropriate message to the second user.

14. A communications system according to claim 12 and claim 13, wherein the Web server is configured to compare the source of the new message with a set of users for which the second user has provided notification authorisation, and to notify the second user only if the source of the message is included in the set of users for which notification authorisation has been provided.

15. A communications system according to any preceding claim, wherein the Web server is administrated by a third party, and is accessed by the first and second users via the Internet.

16. A communications system according to any of claims 1 to 14, wherein the Web server is administrated by the first user and the Web server may be accessed by the first user via an intranet, wherein in order to open the electronic communication sent by the first user the second user must access the Web server via the Internet.

17. A communications system according to any preceding claim, wherein the electronic communication comprises text which is written into a Web browser by the first user and then transferred to the Web server.

18. A communications system according to any of claims 1 to 16, wherein the electronic communication is a voice message.

19. A communications system according to any preceding claim, wherein the electronic communication is sent by the first user from a computer, television set-top box or telephone.

20. A communications system according to any preceding claim, wherein the electronic communication is read by the second user via a computer, television set-top box or telephone.

21. A method of facilitating communication between first and second users via a Web server hosting a Web site accessible via the Internet, the method comprising receiving at the Web server identification details from the first user together with an electronic communication, retaining the electronic communication at the Web server, receiving identification details from the second user, then allowing the second user to open the electronic communication, the method further comprising retaining status information at the Web server indicating whether the electronic communication has been opened by the second user, the status information being accessible to at least the first user.

22. A program storage device readable by a machine and encoding a program of instructions for executing the method steps of claim 21.

23. A user interface located at a user device for use by a first user in communicating with a second user, the user device comprising:
an output mechanism outputting to a Web server an electronic communication from the first user; and
an input mechanism receiving an electronic communication from the Web server, and also receiving status information from the Web server which indicates whether an electronic communication outputted to the Web server has been opened by the second user.

24. A communications system substantially as hereinbefore described with reference to the accompanying figures.

25. A method of communication substantially as hereinbefore described with reference to the accompanying figures.
